(19) United States
(12) Patent Application Publication
(10) Pub. No.: US 2009/0084715 A1
(43) Pub. Date: Apr. 2, 2009

(54) PAPER SHEET SEPARATING APPARATUS

(75) Inventor: Koujirou Sakata, Kawasaki-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/210,574

(22) Filed: Sep. 15, 2008

(30) Foreign Application Priority Data
Sep. 28, 2007 (JP) 2007-255957
Jul. 16, 2008 (JP) 2008-129236

(51) Int. Cl. B07C 5/00

(52) U.S. Cl. 209/643

(57) ABSTRACT

An apparatus according to the present invention is provided with a suction pump which produces a negative pressure on a curved surface of a conveyor curved along a suction roller by drawing air from within the suction roller. Paper sheets which are conveyed by the conveyor are separated based on whether or not the paper sheets are stuck to the curved surface by suction.

### CROSS-REFERENCE TO RELATED APPLICATIONS

This application is based upon and claims the benefit of priority from prior Japanese Patent Applications No. 2007-255957, filed Sep. 28, 2007; and No. 2008-129236, filed May 16, 2008, the entire contents of both of which are incorporated herein by reference.

### BACKGROUND OF THE INVENTION

1. Field of the Invention

The present invention relates to a paper sheet separating apparatus applicable to, for example, an automatic discriminating-jogging imprinter for mail pieces and configured to separate those mail pieces which are unfit for machine-processing.

2. Description of the Related Art

An automatic discriminating-jogging imprinter for mail pieces is provided with a hopper section into which various mail pieces are fed. The mail pieces in the hopper section are delivered to a discriminating section. In the discriminating section, mail pieces with a predetermined thickness and a predetermined width are discriminated from ones with different thicknesses and widths. The mail pieces with the predetermined thickness and width that are discriminated in the discriminating section are transferred to an imprinting section, in which they are imprinted with information. Based on the imprinted information, the discriminated mail pieces are sorted and stored (see Jpn. Pat. Appln. KOKAI Publication No. 2001-253615, for example).

In this automatic discriminating-jogging imprinter, the discriminating section cannot discriminate mail pieces with thicknesses smaller than the predetermined thickness, that is, thin non-resilient mail pieces with low bending strength, such as PPC mail pieces, which are unfit for machine-processing. Unless these thin non-resilient mail pieces are removed, however, they inevitably cause jamming, soiling, or breakage.

Conventionally, therefore, thin non-resilient mail pieces are separated by hand.

In manually separating thin non-resilient mail pieces, however, they must be instantly discriminated by visual observation. Thus, the discrimination itself is difficult, so that the accuracy and efficiency of separation are poor.

### BRIEF SUMMARY OF THE INVENTION

The present invention has been made in consideration of these circumferences, and its object is to provide a paper sheet separating apparatus capable of automatically separating even non-resilient paper sheets.

An apparatus according to an aspect of the invention comprises: at least one conveying device composed of a suction roller having a suction hole in a peripheral surface portion thereof and a conveying member which is passed around the suction roller and configured to convey paper sheets by traveling, the conveying member having a suction hole in a surface thereof which communicates with the suction hole of the suction roller; and a negative-pressure producing device which produces a negative pressure on a curved surface of the conveying member curved along the suction roller by drawing air from within the suction roller, the paper sheets which are conveyed by the conveying device being separated based on whether or not the paper sheets are stuck to the curved surface by suction.

An apparatus according to another aspect of the invention comprises: a conveying device composed of a suction roller having a suction hole in a peripheral surface portion thereof and a conveying member which is passed around the suction roller and configured to convey paper sheets by traveling, the conveying member having a suction hole which communicates with the suction hole of the suction roller; a negative-pressure producing device which produces a negative pressure on a curved surface of the conveying member curved along the suction roller by drawing air from within the suction roller; and a pressing device which presses the leading end side of the paper sheet conveyed by the conveying member against the curved surface of the conveying member, the paper sheets which are pressed by the pressing device being separated based on whether or not the paper sheets are stuck to the curved surface of the conveying member by suction.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing a paper sheet separating apparatus according to a first embodiment of the invention;

FIG. 2 is a side view showing the paper sheet separating apparatus of FIG. 1;

FIG. 3A is a view showing a paper sheet separating operation by the paper sheet separating apparatus of FIG. 1;

FIG. 3B is a view showing the paper sheet separating operation by the paper sheet separating apparatus of FIG. 1;

FIG. 3C is a view showing the paper sheet separating operation by the paper sheet separating apparatus of FIG. 1;

FIG. 4A is a view showing the paper sheet separating operation by the paper sheet separating apparatus of FIG. 1;

FIG. 4B is a view showing the paper sheet separating operation by the paper sheet separating apparatus of FIG. 1;

FIG. 4C is a view showing the paper sheet separating operation by the paper sheet separating apparatus of FIG. 1;

FIG. 5 is a perspective view showing a paper sheet separating apparatus according to a second embodiment of the invention;

FIG. 6A is a view showing a paper sheet separating operation by the paper sheet separating apparatus of FIG. 5;

FIG. 6B is a view showing the paper sheet separating operation by the paper sheet separating apparatus of FIG. 5;

FIG. 7 is a perspective view showing a paper sheet separating apparatus according to a third embodiment of the invention;

FIG. 8 is a front view showing the paper sheet separating apparatus of FIG. 7;

FIG. 9 is a perspective view showing a paper sheet separating apparatus according to a fourth embodiment of the invention;

FIG. 10 is a plan view showing the paper sheet separating apparatus of FIG. 9;

FIG. 11A is a view showing a paper sheet separating operation by the paper sheet separating apparatus of FIG. 9;

FIG. 11B is a view showing the paper sheet separating operation by the paper sheet separating apparatus of FIG. 9;

FIG. 11C is a view showing the paper sheet separating operation by the paper sheet separating apparatus of FIG. 9;

FIG. 12 is a perspective view showing a paper sheet separating apparatus according to a fifth embodiment of the invention;

FIG. 13 is a side view showing the paper sheet separating apparatus of FIG. 12;

FIG. 14A is a view showing guide directions for paper sheets separated by the paper sheet separating apparatus of FIG. 12;

FIG. 14B is a view showing a guide direction for a paper sheet separated by the paper sheet separating apparatus of FIG. 12;

FIG. 15A is a view showing a guide direction for a paper sheet separated by the paper sheet separating apparatus of FIG. 12;

FIG. 15B is a view showing a guide direction for a paper sheet separated by the paper sheet separating apparatus of FIG. 12;

FIG. 15C is a view showing a guide direction for a paper sheet separated by the paper sheet separating apparatus of FIG. 12;

FIG. 16 is a side view showing a paper sheet separating apparatus according to a sixth embodiment of the invention;

FIG. 17 is an enlarged view showing the paper sheet unloading side of the paper sheet separating apparatus of FIG. 16;

FIG. 18 is a view showing how a paper sheet with a deformable leading end portion is conveyed by a conveyor of FIG. 16;

FIG. 19 is a view showing a state in which the deformed leading end portion of the paper sheet conveyed by the conveyor of FIG. 16 abuts a pressure roller;

FIG. 20 is a view showing how the deformed leading end portion of the paper sheet abutting the pressure roller of FIG. 19 is pressed against the curved surface side of the conveyor by the pressure roller; and

FIG. 21 is a view showing how a paper sheet with a deformable leading end is discharged without the use of the pressure roller.

### DETAILED DESCRIPTION OF THE INVENTION

Embodiments of the present invention will now be described in detail with reference to the accompanying drawings.

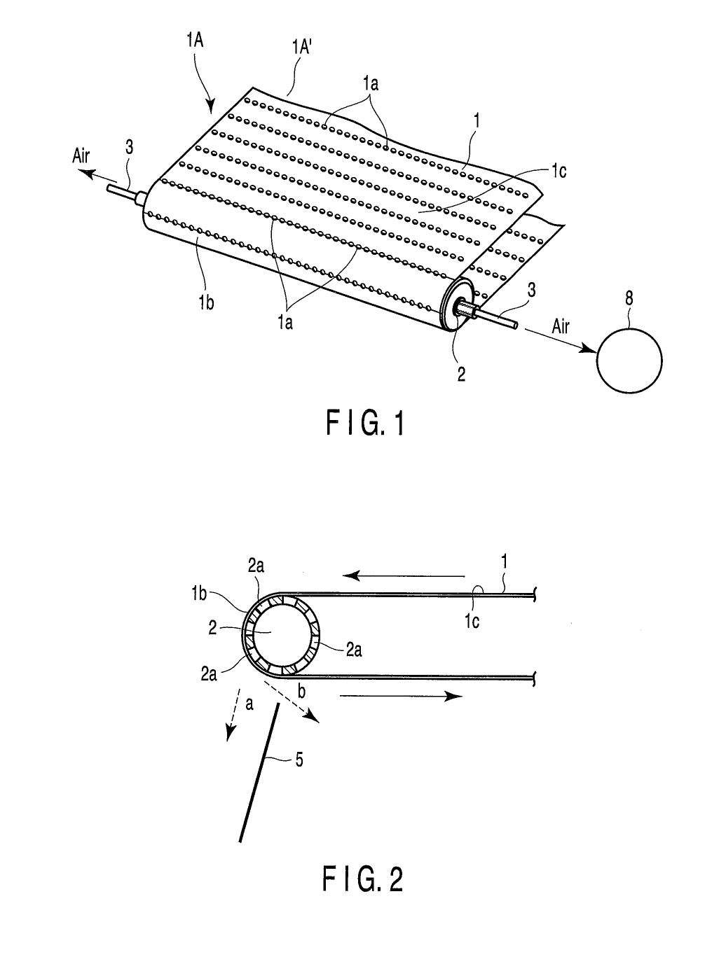

FIG. 1 is a perspective view showing a paper sheet separating apparatus 1A according to a first embodiment of the invention, and FIG. 2 is a side view of the apparatus 1A. In FIG. 1, 1A′ denotes a conveying device, which is provided with a conveyor 1, such as a belt, for use as a conveying member that carries paper sheets, such as mail pieces, on its transfer surface 1c and conveys them. The unloading side of the conveyor 1 is passed around a driving suction roller 2 and is run as the roller 2 rotates. A large number of suction holes 1a are bored through the surface of the conveyor 1. Suction holes 2a are bored through a peripheral wall surface portion of the suction roller 2. A suction pump 8 for use as a negative-pressure producing device is connected to each of two opposite end surface portions of the suction roller 2 by an air suction pipe 3. The conveyor 1 is curved along the suction roller 2. A negative pressure is produced on a curved surface 1b of the conveyor 1 as the suction holes 1a of the conveyor 1 communicate with the suction holes 2a of the roller 2.

Further, a distributor wall 5 is disposed under the unloading side of the conveyor 1. The wall 5 serves as a guide device that guides paper sheets conveyed and dropped from the conveyor 1 in first and second directions a and b.

The following is a description of operations for separating the paper sheets.

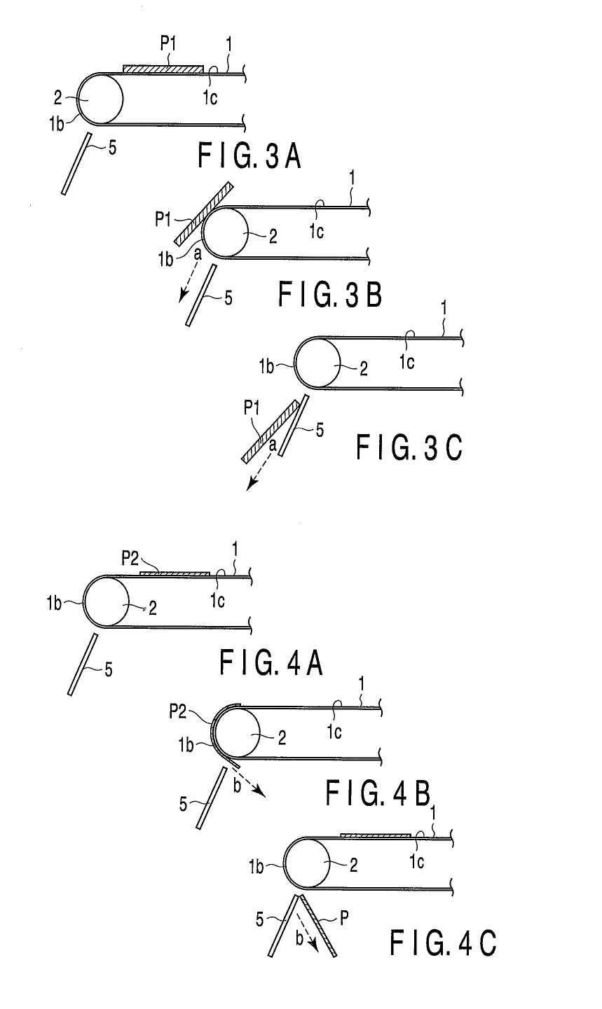

FIGS. 3A, 3B and 3C show an operation for separating a resilient paper sheet P1 with high bending strength.

The paper sheet P1 is placed on the transfer surface 1c of the conveyor 1 and conveyed in the manner shown in FIG. 3A. When this is done, the suction pumps 8 are operated to draw out air in the suction roller 2 through the air suction pipes 3. Thereupon, a negative pressure is produced on the unloading-side curved surface 1b of the conveyor 1.

When the paper sheet P1 reaches the side of the curved surface 1b of the conveyor 1, it is drawn in, as shown in FIG. 3B. When this is done, the resilient paper sheet P1 cannot be curvedly deformed along the curved surface 1b of the conveyor 1. Then, the tough paper sheet P1 is dropped from the curved surface 1b of the conveyor 1 by its own weight without failing to maintain its shape, as shown in FIG. 3C. The dropped paper sheet P1 is guided in the first direction a by the distributor wall 5.

FIGS. 4A, 4B and 4C show an operation for separating a non-resilient paper sheet P2 with low bending strength.

The paper sheet P2 is placed on the transfer surface 1c of the conveyor 1 and conveyed in the manner shown in FIG. 4A. When the paper sheet P2 reaches the side of the curved surface 1b of the conveyor 1, as shown in FIG. 4B, it is deformed by suction as it is conveyed along the curved surface 1b. The paper sheet P2 is conveyed for a longer distance than the resilient paper sheet P1 is, and ceases to receive a suction force when it passes the distributor wall 5, as shown in FIG. 4C. Thereupon, the paper sheet P2 is dropped by its own weight and guided in the second direction b by the distributor wall 5. The resilient paper sheet P1 and the non-resilient are separated in this manner.

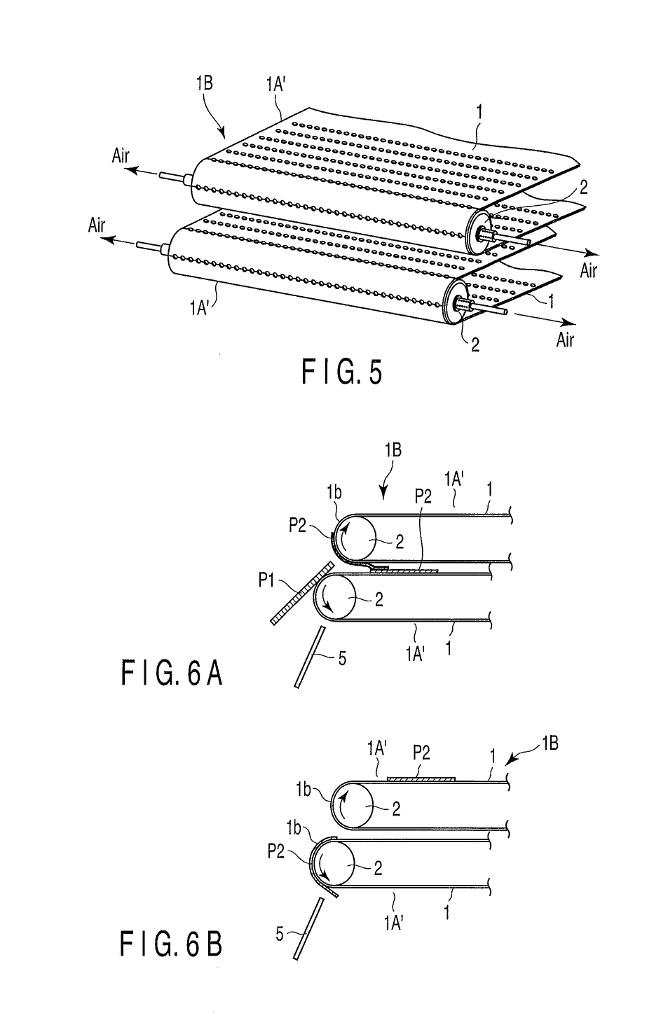

FIG. 5 shows a paper sheet separating apparatus 1B according to a second embodiment of the invention.

Like numbers are used to designate like portions of the first and second embodiments and a detailed description thereof is omitted.

The paper sheet separating apparatus 1B of the second embodiment is composed of the aforementioned conveying devices 1A′ that are arranged with a predetermined vertical space therebetween.

According to this second embodiment, resilient paper sheets P1 and non-resilient paper sheets P2 can be separated in the same manner as in the first embodiment described above by means of the lower conveying device 1A′.

If two adjacent non-resilient paper sheets P2 overlap each other as they are conveyed, according to the second embodiment, moreover, the upper paper sheet P2 is drawn up by the curved surface 1b of the upper conveyor 1, as shown in FIG. 6A. Thus, the non-resilient paper sheets P2 can be separated above and below by the lower conveying device 1A′, as shown in FIG. 6B.

According to the second embodiment, furthermore, thin paper sheets can be separated more finely by differentiating the suction pressures of the upper and lower conveying devices 1A′. For example, the paper sheets can be separated more delicately in such a manner that thinner ones are stuck to the curved surface 1b of the upper conveyor 1 and conventional thin sheets to the curved surface 1b of the lower conveyor 1.

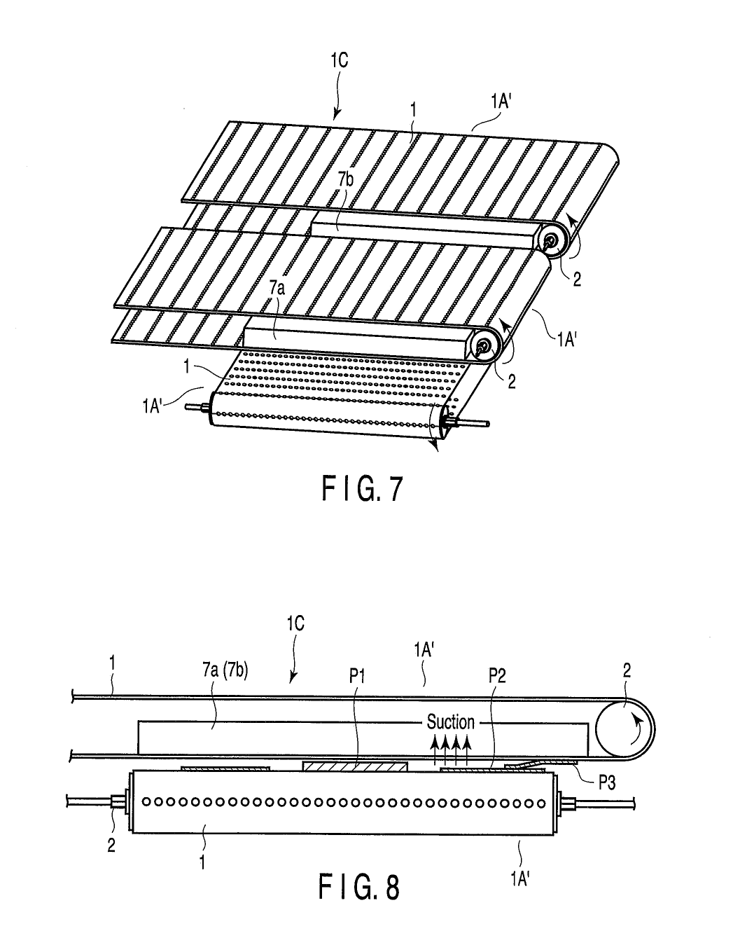

FIG. 7 shows a paper sheet separating apparatus 1C according to a third embodiment of the invention.

Like numbers are used to designate like portions of the first and third embodiments and a detailed description thereof is omitted.

In the paper sheet separating apparatus 1C of this third embodiment, a plurality of conveying devices 1A′ are arranged parallel to one another so as to be spaced upward from and extend at right angles to the aforementioned conveying device 1A′. Further, the conveying devices 1A′ on the upper side are provided individually with suction chambers 7a and 7b with different suction forces, which are situated near the suction rollers 2.

According to this third embodiment, resilient paper sheets P1 and non-resilient paper sheets P2 can be separated in the same manner as in the foregoing first embodiment by means of the lower conveying device 1A′. As shown in FIG. 8, moreover, paper sheets P3 that are thinner than the non-resilient paper sheets P2 can be separated after being stuck to the upper conveyor 1 by the suction forces of the suction chambers 7a and 7b of the parallel conveying devices 1A′ on the upper side.

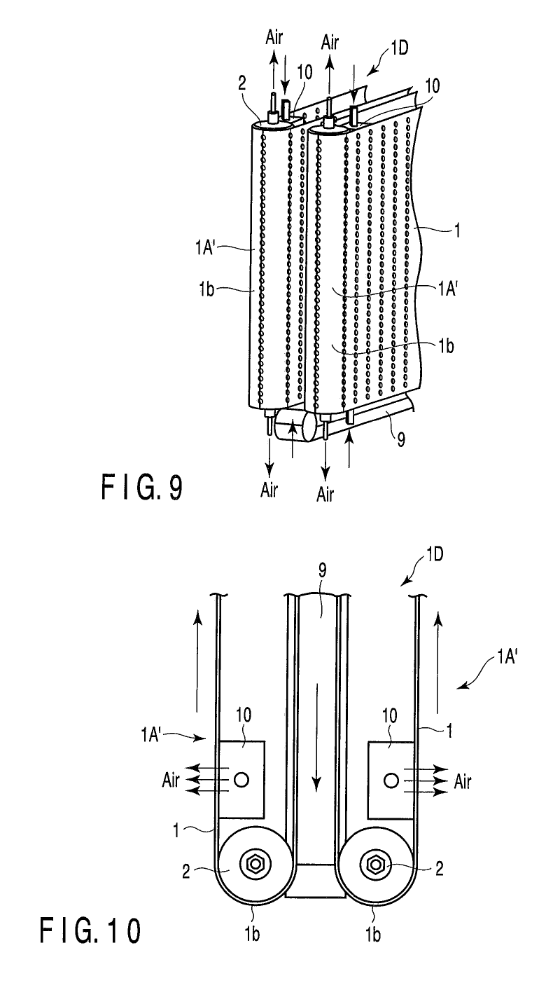

FIG. 9 shows a paper sheet separating apparatus 1D according to a fourth embodiment of the invention.

Like numbers are used to designate like portions of the first and fourth embodiments and a detailed description thereof is omitted.

In this fourth embodiment, the conveying devices 1A′ shown in FIG. 1 are arranged upright and parallel to each other with a predetermined space therebetween, and a floor conveyor belt 9 is provided between the respective lower end portions of the conveying devices 1A′. As also shown in FIG. 10, moreover, each upright conveying device 1A′ is provided with a blow-off chamber 10 that is situated near its suction roller 2.

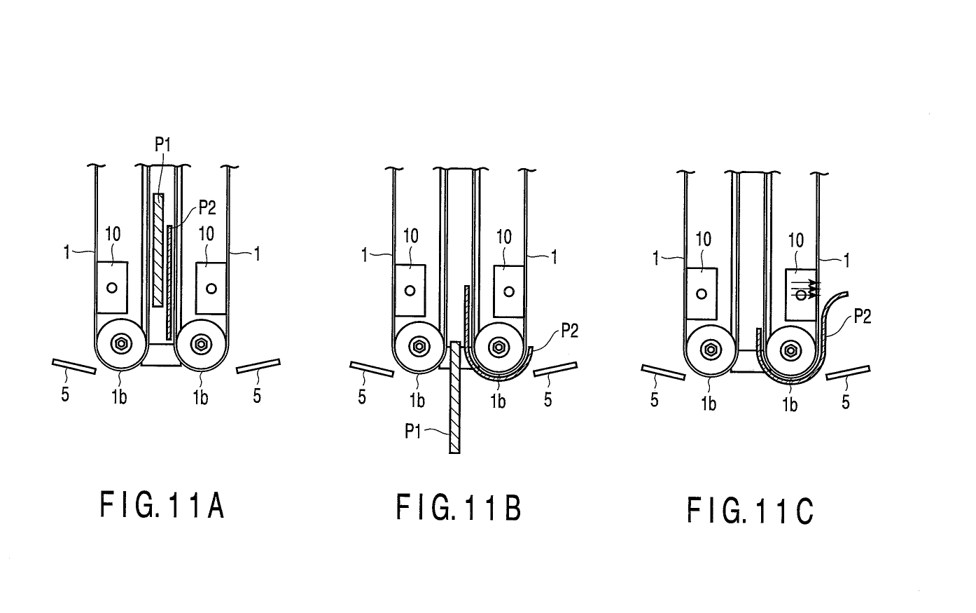

As shown in FIG. 11A, a thick paper sheet P1 and a thin paper sheet P2 are placed upright on the floor conveyor belt 9 and conveyed, as shown in FIG. 11A. When they reach the unloading side, the paper sheets P1 and P2 are separated, as shown in FIG. 11B. More specifically, the thick paper sheet P1 is delivered as it is, while the thin paper sheet P2 is deformed by suction as it is delivered along the curved surface 1b of the conveyor 1. When the separated thin paper sheet P2 reaches the side of the blow-off chamber 10, it is blown by air from the chamber 10 and separated from the conveyor 1, as shown in FIG. 11C.

According to this fourth embodiment, the resilient and non-resilient paper sheets P1 and P2 can be separated in the same manner as in the foregoing first embodiment. Since air is blown against the separated thin paper sheet P2 to force it to be separated from conveyor 1, moreover, the paper sheet P2 cannot be electrostatically attracted to the conveyor 1 even static electricity or the like is generated in suction roller 2.

Since the conveying devices 1A′ are arranged upright and parallel to each other, the occupied plane area can be made smaller than in the case where the conveying devices 1A′ are arranged horizontally.

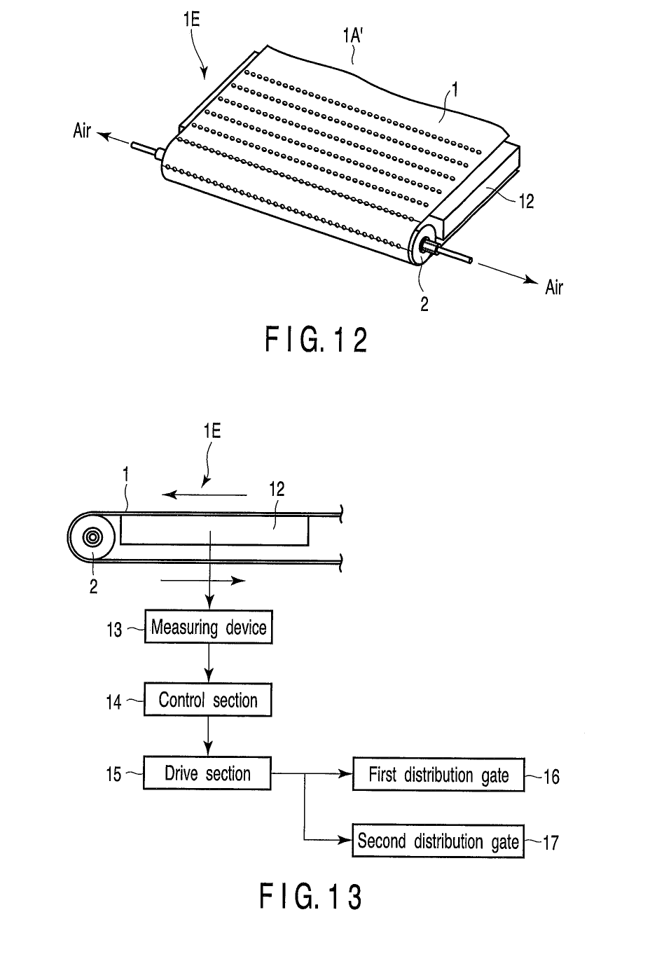

FIGS. 12 to 15C show a paper sheet separating apparatus 1E according to a fifth embodiment of the invention.

Like numbers are used to designate like portions of the first and fifth embodiments and a detailed description thereof is omitted.

In this fifth embodiment, the conveyor 1 is provided with a suction chamber 12 that is situated near its suction roller 2.

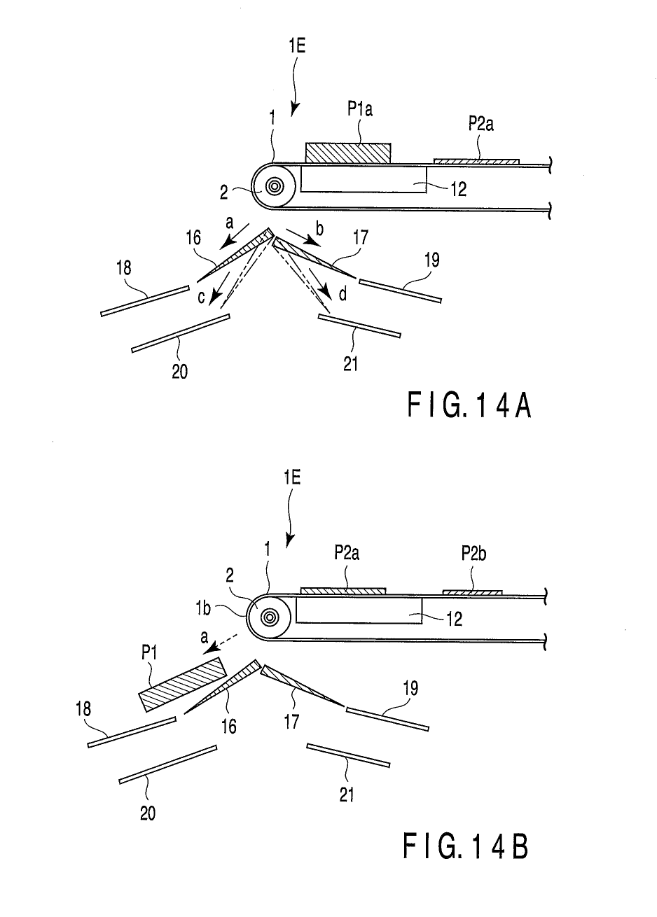

As shown in FIG. 14A, moreover, first and second distribution gates 16 and 17 that are rockable vertically are arranged below the unloading side of the conveyor 1. The distribution gates 16 and 17 guide the paper sheets in the first and second directions a and b by rocking upward. Further, the paper sheets that are guided in the first and second directions a and b are guided by upper guides 18 and 19, respectively.

As the first and second distribution gates 16 and 17 are rocked downward, furthermore, they guide the paper sheets in third and fourth directions c and d. The paper sheets guided in the third and fourth directions c and d are guided by lower guides 20 and 21, respectively.

As shown in FIG. 13, on the other hand, a measuring device 13 is connected to the suction chamber 12, and a drive section 15 is connected to the measuring device 13 through a control section 14. The measuring device 13 measures a negative pressure of the suction chamber 12, and the control section 14 controls the drive section 15 based on the measured negative pressure. The drive section 15 vertically rocks the first and second distribution gates 16 and 17.

The control section 14 controls the drive section 15 so as to rock the first and second distribution gates 16 and 17 upward if a high negative pressure is measured. Further, the control section 14 controls the drive section 15 so as to rock the distribution gates 16 and 17 downward if a low negative pressure is measured.

When a paper sheet is conveyed by the conveyor 1 and reaches the side of the suction chamber 12, in the arrangement described above, the negative pressure of the suction chamber 12 is measured by the measuring device 13. If the paper sheet is a large thick one, that is, a resilient paper sheet P1a with a large area, as shown in FIG. 14A, for example, a high negative pressure is measured by the measuring device 13. Based on this measurement, the first and second distribution gates 16 and 17 are rocked upward by the drive section 15. The paper sheet P1a to be unloaded from the conveyor 1 is dropped without being deformed by suction along the curved surface 1b of the conveyor 1. As shown in FIG. 14B, the paper sheet P1a is fed in the first direction a by the first distribution gate 16 and guided along the upper guide 18.

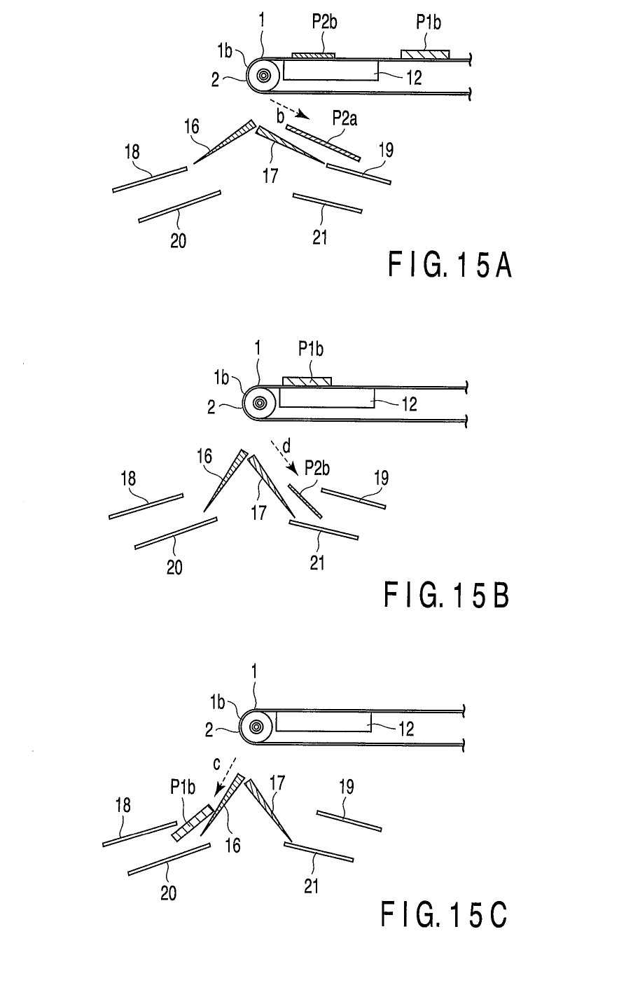

When a large thin paper sheet, that is, a non-resilient paper sheet P2a with a large area, reaches the side of the suction chamber 12, as shown in FIG. 14B, moreover, a high negative pressure is also measured by the measuring device 13. Based on this measurement, the first and second distribution gates 16 and 17 are rocked upward by the drive section 15. The paper sheet P2a to be unloaded from the conveyor 1 is dropped after being stuck to and conveyed along the curved surface 1b of the conveyor. As shown in FIG. 15A, the paper sheet P2a is fed in the second direction b by the second distribution gate 17 and guided along the second guide 19.

When a small thin paper sheet, that is, a non-resilient paper sheet P2b with a small area, reaches the side of the suction chamber 12, as shown in FIG. 15A, moreover, a low negative pressure is measured by the measuring device 13. Based on this measurement, the first and second distribution gates 16 and 17 are rocked downward by the drive section 15. The paper sheet P2b to be unloaded from the conveyor 1 is dropped after being stuck to and conveyed along the curved surface 1b of the conveyor. As shown in FIG. 15B, the paper sheet P2b is fed in the fourth direction d by the second distribution gate 17 and guided along the fourth guide 21.

When a small thick paper sheet, that is, a resilient paper sheet P1b with a small area, reaches the side of the suction chamber 12, as shown in FIG. 15B, furthermore, a low negative pressure is measured by the measuring device 13. Based on this measurement, the first and second distribution gates 16 and 17 are rocked downward by the drive section 15. The resilient paper sheet P1b is dropped along the curved surface 1b of the conveyor 1 without being stuck to it by suction. As shown in FIG. 15C, the paper sheet P1b is fed in the third direction c by the first distribution gate 16 and guided along the third guide 20.

Thus, the paper sheets are classified into four types, i.e., the large thick sheets P1a, large thin sheets P2a, small thick sheets P1b, and small thin sheets P2b.

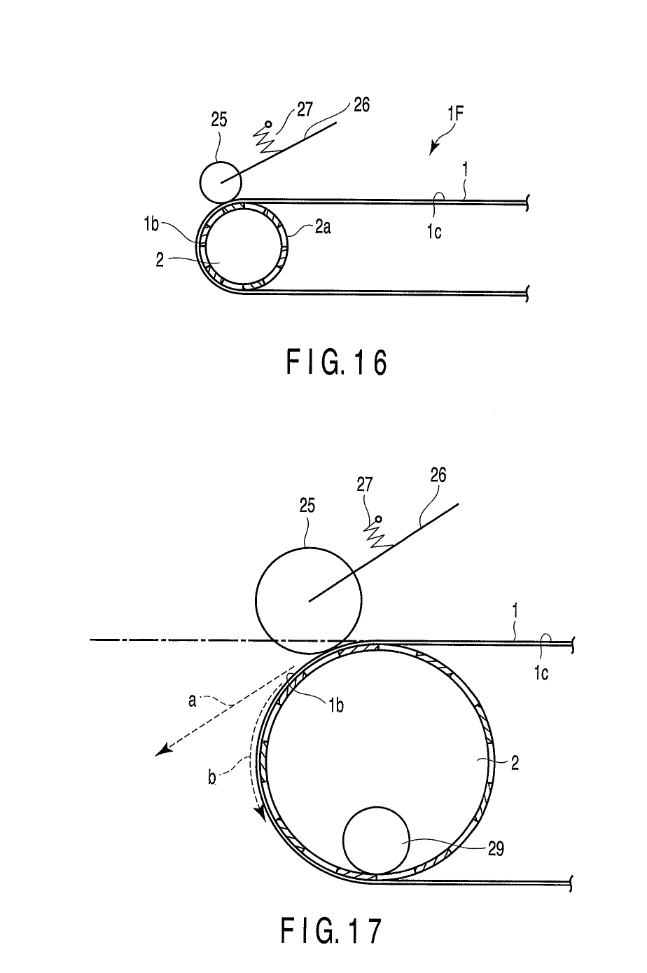

FIG. 16 shows a paper sheet separating apparatus 1F according to a sixth embodiment of the invention.

Like numbers are used to designate like portions of the first and sixth embodiments and a detailed description thereof is omitted.

In this sixth embodiment, a pressure roller 25 is located over the unloading side of the conveyor 1. The roller 25 serves as a pressing device that presses the leading end portion of each paper sheet conveyed by the conveyor 1. The pressure roller 25 is rockably mounted on a rocking end portion of rocking lever 26. The rocking lever 26 is elastically urged by a spring 27 so that the pressure roller 25 abuts the suction roller 2. As shown in FIG. 17, the position of contact between the rollers 2 and 25 is situated below the transfer surface 1c of the conveyor 1 so that the leading end portion of each paper sheet can be pressed against the curved surface 1b of the conveyor 1.

Further, a sound-absorbing roller 29 is provided within the suction roller 2. The sound-absorbing roller 29 is axially shorter than the suction roller 2 and is contained in the suction roller 2.

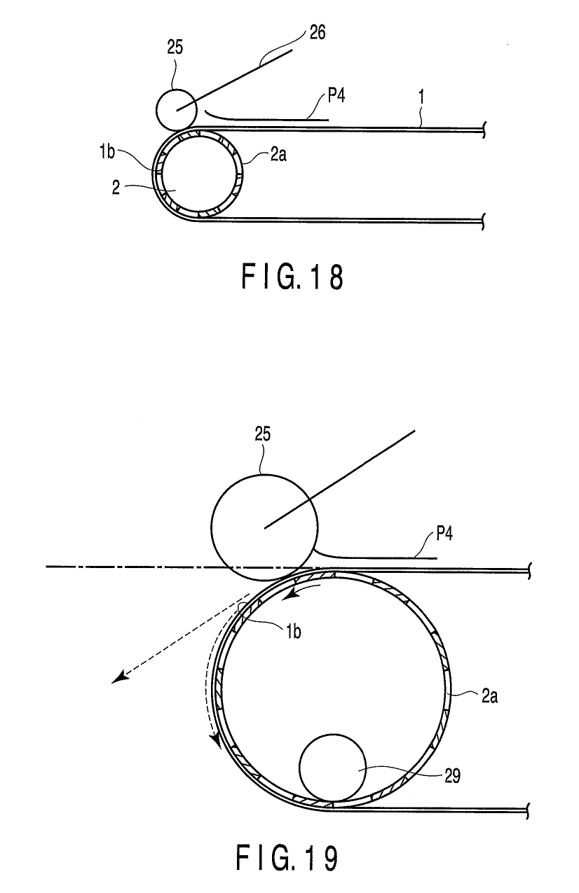

According to this sixth embodiment, as in the foregoing first embodiment, the resilient and non-resilient paper sheets P1 and P2 can be separated in the same manner as in the foregoing first embodiment. As shown in FIG. 18, moreover, even a non-resilient paper sheet P4 with its leading end bent away from the curved surface 1b or folded can be separated.

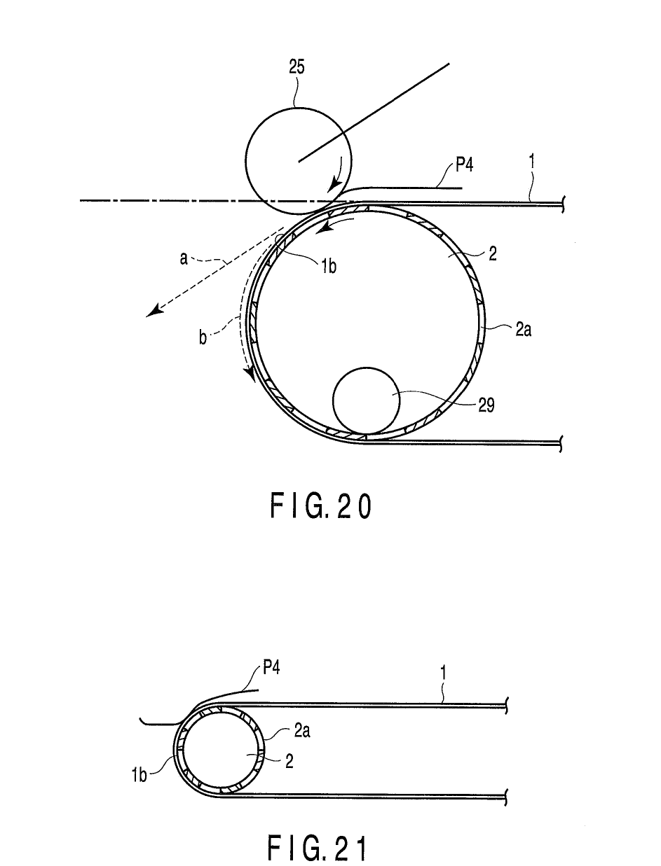

Specifically, when the paper sheet P4 is conveyed to the unloading side by the conveyor 1 so that its deformed leading end portion abuts the pressure roller 25, as shown in FIG. 19, it is caught and swallowed as the pressure roller 25 rotates, as shown in FIG. 20. Thereupon, the paper sheet P4 is stuck to the curved surface 1b of conveyor 1 by suction as it is conveyed in the direction of arrow b, and is then separated.

If the pressure roller 25 is not provided, as shown in FIG. 21, the paper sheet P4 with the deformable leading end portion is conveyed without being stuck to the curved surface 1b of the conveyor 1 by suction, so that it may possibly fail to be separated.

Further, a resonant sound may sometimes be produced by a whistling effect when air is drawn from within the suction roller 2. In such a case, the sound-absorbing roller 29 rolls within the suction roller 2, thereby preventing the production of the resonant sound.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A paper sheet separating apparatus comprising:
at least one conveying device composed of a suction roller having a suction hole in a peripheral surface portion thereof and a conveying member which is passed around the suction roller and configured to convey paper sheets by traveling, the conveying member having a suction hole in a surface thereof which communicates with the suction hole of the suction roller; and
a negative-pressure producing device which produces a negative pressure on a curved surface of the conveying member curved along the suction roller by drawing air from within the suction roller,
the paper sheets which are conveyed by the conveying device being separated based on whether or not the paper sheets are stuck to the curved surface by suction.

2. A paper sheet separating apparatus according to claim 1, further comprising a guide device which guides the separated paper sheets in a first direction and a second direction different from the first direction.

3. A paper sheet separating apparatus according to claim 1, wherein the conveying devices are arranged opposite each other with a predetermined vertical space therebetween, and the paper sheets are separated based on whether or not the paper sheets are stuck to the curved surfaces of the respective conveying members of the upper and lower conveying devices by suction.

4. A paper sheet separating apparatus according to claim 1, wherein the conveying devices are arranged across and opposite each other with a predetermined vertical space therebetween, the upper conveying device is provided with a suction chamber, and the paper sheets with thicknesses smaller than a predetermined thickness, among other paper sheets conveyed by the lower conveying device, are stuck to the surface of the conveying member of the upper conveying device by a suction force of the suction chamber as the thin paper sheets are conveyed.

5. A paper sheet separating apparatus according to claim 1, wherein the conveying devices are arranged upright and opposite each other with a predetermined space therebetween, a floor conveying device for conveying the paper sheets is provided between the respective lower end portions of the conveying devices, and the conveying devices are provided with blow-off chambers, individually, such that air from the blow-off chamber is blown against those paper sheets which are stuck to the curved surfaces of the respective conveying members of the conveying devices by suction and are to be separated and conveyed, among other paper sheets conveyed by the floor conveyor device, whereby the stuck paper sheets are separated from the surface of the conveying member.

6. A paper sheet separating apparatus according to claim 1, further comprising a suction chamber which is disposed in the conveying device and produces a negative pressure on the surface of the conveying member of the conveying device, a measuring device which measures the negative pressure in the suction chamber, and a distribution gate which is operated based on the negative pressure measured by the measuring device and guides the paper sheets, which are separated based on whether or not the paper sheets are stuck to the curved surface of the conveying member by suction, in different directions depending on the sizes of the paper sheets.

7. A paper sheet separating apparatus comprising:
a conveying device composed of a suction roller having a suction hole in a peripheral surface portion thereof and a conveying member which is passed around the suction roller and configured to convey paper sheets by traveling, the conveying member having a suction hole which communicates with the suction hole of the suction roller;
a negative-pressure producing device which produces a negative pressure on a curved surface of the conveying member curved along the suction roller by drawing air from within the suction roller; and
a pressing device which presses the leading end side of the paper sheet conveyed by the conveying member against the curved surface of the conveying member,
the paper sheets which are pressed by the pressing device being separated based on whether or not the paper sheets are stuck to the curved surface of the conveying member by suction.

8. A paper sheet separating apparatus according to claim 7, wherein the pressing device is a pressure roller which abuts the curved surface of the conveying member.

9. A paper sheet separating apparatus according to claim 7, wherein the suction roller contains therein a sound-absorbing roller having sound absorption properties.

10. A paper sheet separating apparatus according to claim 8, wherein the position where the pressure roller abuts the curved surface of the conveying member is situated below a transfer surface of the conveying member.

11. A paper sheet separating apparatus according to claim 8, wherein the pressure roller is movable toward or away from the curved surface of the conveying member and is elastically urged toward the curved surface of the conveying member.
